(19) United States
(12) Patent Application Publication
(10) Pub. No.: US 2004/0182267 A1
(43) Pub. Date: Sep. 23, 2004

(54) Plate material for printing and method for regenerating/reusing plate material for printing and printing machine

(76) Inventors: Yasuharu Suda, Hiroshima-ken (JP); Toyoshi Ohto, Hiroshima-ken (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/482,171

(22) PCT Filed: Jan. 30, 2003
(86) PCT No.: PCT/JP03/00892

(30) Foreign Application Priority Data
Feb. 12, 2002 (JP) 2002-034502

(51) Int. Cl. B41N 1/00

(52) U.S. Cl. 101/453

(57) ABSTRACT

A printing plate has a surface layer (3) including a photocatalyst that responds to visible light as well as ultraviolet light so that it is possible to form an image on the surface of the printing plate by irradiating with visible light and to regenerate the printing plate by deleting the formed image whereupon the printing plate can be reused.

### TECHNICAL FIELD

The present invention relates to a reusable printing plate on which an image is formed by irradiating a surface of the printing plate with light and which is regenerated by deleting the image formed on the surface, to a method for regenerating and reusing the printing plate, and to a printing press on which the above printing plate is mounted and which allows the printing plate to be made ready for printing and be regenerated being mounted on the printing press.

### BACKGROUND OF THE INVENTION

In recent years, digitalization of printing processes has been progressing in the art. This technology involves creation of images and manuscripts in digitized form on a personal computer or reading images with a scanner and directly makes a printing plate based on the digital data thus obtained. This makes it possible to save labor in the whole printing processes and also to conduct high-definition printing with ease.

So-called PS plates (presensitized plates) have been commonly used as printing plates to date. A PS plate includes a hydrophilic non-image area made of anodized aluminum and one or more hydrophobic image areas formed by curing a photosensitive resin on the surface of the anodized aluminum. Making a printing plate ready for printing with such a PS plate requires a number of steps and hence, is time-consuming and costly. It is therefore difficult to reduce the time and the cost required for a printing process. Especially in short-run printing, the requirement for such plural steps causes increased printing costs. Additionally, since use of a PS plate requires a development step using a developer, serious problems arise not only with the need for considerable amounts of labor but also with environmental pollution caused by treatment of developer waste in view of the prevention of environmental pollution.

Further, it is a common practice to expose a PS plate the surface of which is in contact with a film through which a desired image is perforated to light. This causes problems in making the printing plate ready for printing directly from digital data and in promoting a digitized printing process. Moreover, after completion of printing of a pattern, it has been necessary to replace the printing plate with another one in order to conduct printing of the next pattern, and used printing plates have been thrown away.

To solve the above-described problems of PS plates, methods have been proposed to meet the digitization of printing process while making it possible to omit the development step, and some of such methods have come into commercial use. For example, Japanese Patent Application Laid-Open (KOKAI) Publication No. SHO 63-102936 discloses a process of making a plate ready for printing comprising the steps of: applying ink containing a photosensitive resin used as an ink for a liquid ink-jet printer to the surface of a printing plate; and curing an image area by irradiation with light. Japanese Patent Application Laid-Open (KOKAI) Publication No. HEI 11-254633, on the other hand, discloses a process for making a color offset printing plate ready for printing by an ink-jet head through which solid ink is jetted.

Also included in known methods are a process for making a printing plate ready for printing, which comprises the step of, writing with a laser beam, an image on a printing plate, which is made of a PET (polyethylene terephthalate) film on which a laser absorbing layer such as carbon black covered with a silicone resin layer is formed, to cause the laser absorbing layer to evolve heat, which ablates off the silicone resin layer; and another process for preparing a printing plate ready for printing comprising the step of coating a lipophilic laser absorbing layer on an aluminum plate, coating a hydrophilic layer on the laser absorbing layer, and then ablating off the hydrophilic layer with a laser beam as in the above-described process.

Another proposed method discloses a printing plate made of a hydrophilic polymer, which plate is made ready for printing by lipophilizing an irradiated portion subjected to image exposure. Further, a method in which an image is written on a PS plate with a laser beam directly from digital data is disclosed and a so-called CTP (Computer to Plate) that is an imaging device utilizes a violet laser beam having a wavelength of 405 nm, or a combination of a micromirror and a UV lamp is available on the market.

Although these method can make a printing plate ready for printing directly from digital data, replacement of a printing plate after printing one pattern with a new printing plate is required for the next printing. Therefore, these methods do not improve on the point that a printing plate used for one printing process is discarded.

For example, Japanese Patent Application Laid-Open (KOKAI) Publication No. HEI 10-250027 refers to a latent image block copy making use of a titanium dioxide photocatalyst, a fabrication process of the latent image block, and a printing press having the latent image block. Japanese Patent Application Laid-Open (KOKAI) Publication No. HEI 11-147360 also discloses an offset printing process of a printing plate making use of a photocatalyst. Each of these disclosures forms an image using light, i.e., ultraviolet light, practically, to activate the photocatalyst and regenerates the printing plate by hydrophobization of the photocatalyst caused by a heat treatment.

Further, Japanese Patent Application Laid-Open (KOKAI) Publication No. HEI 11-105234 discloses a method for making a printing plate ready for printing comprising the step of hydrophilizing a photocatalyst with activating light, i.e., ultraviolet light, and then forming an image area by a heat-mode recording.

As disclosed in the paper (pages 124-125) entitled “Study of Photo-Induced Hydrophilic Conversion on the TiO₂ Surface Involved by Structural Conformation”, (by Minabe et al.) distributed at the Fifth Symposium on “Recent Developments of Photocatalytic Reactions” of the Photo Functionalized Materials Society in 1998, Prof. Fujishima, Prof. Hashimoto, et al. of the Research Center for Advanced Science and Technology, The University of Tokyo, have confirmed that a titanium dioxide photocatalyst is hydrophilized by heat treatment. According to the description in the above paper, the processes disclosed in the above laid-open patent applications referred to in the above, a printing plate cannot be regenerated for reusing or cannot be made a printing plate ready for printing.

Considering the above circumstances, the Inventors have developed a printing plate, on which an image can be written directly from digital data without a wet development step and which can be reused by regeneration, and a regeneration method for the printing plate, and have applied patent applications for the printing plates (Japanese Patent Application numbers HEI 10-229109 and HEI 11-90146).

Successively, the Inventors have been enthusiastically researching to develop a printing plate able to be made ready for printing and be regenerated by a device more tractable for handling and more compact in size.

In other words, the present invention aims at providing a reusable printing plate able to be made ready for printing directly from digital data by a tractable compact device and be regenerated, and a regenerating and reusing method for the printing plate.

Further, the present invention also aims at providing a printing press incorporates a regeneratable printing plate by utilizing the above reusable printing plate, which printing press is tractable for handling and compact in size.

### DISCLOSURE OF THE INVENTION

In order to attain the foregoing aim, there is provided a reusable printing plate on which an image is formed by irradiating a surface of the printing plate with light and which is regenerated by deleting the formed image, wherein a layer serving as the surface of the printing plate includes a photocatalyst that responds to visible light. Since a photocatalyst is activated when being irradiated with light having energy higher than the band-gap energy of the photocatalyst, conventional technique concretely utilizes ultraviolet light as an example. It is sure that ultraviolet light can easily activate a photocatalyst causing the photocatalyst to exhibit photocatalytic activity because of its high energy due to a short wavelength of ultraviolet light. On the other side, ultraviolet light requires to be treated with care and an irradiating unit used for forming an image is large in size. As a solution, in the present invention, the usage of the photocatalyst that responds also to visible light can utilize an irradiating unit for visible light as an image forming unit and a tractable and compact irradiating unit is realized.

Needless to say, a photocatalyst that responds to visible light responds also to ultraviolet light having higher energy than visible light. As a preferable feature, the photocatalyst responds to light having a wavelength equal to or shorter than 600 nm, at least equal to or shorter than 500 nm. In the following description, activating light represents light having energy effective on causing a photocatalyst to exhibit photocatalytic activity.

The photocatalyst has a property that is converted by irradiation with activating light and a property that decomposes an organic compound on the surface. In the present invention, a conversion in a property of the photocatalyst, more specifically conversion from hydrophilic to hydrophobic and from hydrophobic to hydrophilic, causes formation of the image on the surface of the printing plate and regeneration of the printing plate.

With this property, it is possible to convert a portion of the surface of the printing plate to hydrophilic by irradiating the portion with activating light. This is because the irradiating with the activating light converts the property of the photocatalyst from hydrophobic to hydrophilic. The portion converted to hydrophilic serves as a non-image area to which a fountain solution preferentially adheres but hydrophobic ink does not adhere. Conversely, the portion that has not been irradiated with the activating light serves as an image area to which the hydrophobic ink preferentially adheres but the fountain solution does not adhere.

The printing plate can be regenerated by converting the property of the photocatalyst at the non-image area from hydrophilic to hydrophobic. As a preferable feature, the property of the photocatalyst is converted from hydrophilic to hydrophobic by irradiating the surface of the printing plate with energy flux such as light, electricity or heat, or by applying a mechanical stimulus such as friction to the surface of the printing plate so that the surface of the printing plate is regenerated.

The photocatalyst is a titanium oxide photocatalys or a modified titanium oxide photocatalyst. Here, a modified titanium oxide photocatlayst is formed by doping or containing a metal or non-metal element other than elements originally included in the titanium oxide photocatalyst based on the titanium oxide photocatalyst or by changing the stoichimetric ratio of a titanium dioxide photocatalyst in which the ratio of Ti atoms and O atoms are included in a ratio of 1:2. The modified titanium oxide photocatlayst is obtained by improving a titanium oxide photocatalyst so as to respond to visible light as well as ultraviolet light because of setting a new level in the band gap of the titanium oxide photocatalyst.

The present invention also provides a method for regenerating and reusing a printing plate comprising the steps of: upon completion of printing, removing ink from the surface of the printing plate (ink removing step); regenerating the printing plate by deleting the image formed on the surface of the printing plate in accordance with a conversion of a property of the photocatalyst at a non-image area from hydrophilic to hydrophobic which conversion is caused by irradiating the surface of the printing plate with energy flux or by applying a mechanical stimulus to the surface of the printing plate (plate regenerating step); and forming an image on the surface of the printing plate by irradiating a portion of the surface with visible light so that a property of the photocatalyst at the irradiated portion converts from hydrophobic to hydrophilic to make the irradiated portion serve as a non-image area (image forming step). This regenerating and reusing method regenerates and repetitiously uses a printing plate whereupon it is possible to reduce an amount of printing plates discarded after being used for printing, reducing costs for printing plates. Further, since it is possible to reduce time required for regenerating of the printing plate, especially to form an image, during a printing process, time required to prepare for printing can be advantageously reduced.

As a preferable feature, the method further comprising the steps of: before the conversion of the property of the photocatalyst from hydrophilic to hydrophobic in the step of regenerating, irradiating the entire surface of the printing plate with activating light. The irradiation with the activating light makes the entire surface of the printing plate hydrophilic and an image area on the surface is deleted so that it is therefore possible to further evenly regenerate the entire surface of the printing plate. The activating light irradiated is light having a wavelength shorter than that of visible light. Namely, ultraviolet light can be used as well as visible light.

The step of ink removing is performed, for example, by moving the ink to paper while a printing press is operating without supplying the printing plate with ink; by wiping off the ink with a reeled cleaning cloth tape; by wiping off the ink with a roller around which cloth is wrapped; or by spraying a solvent having an effect on washing off ink onto the surface of the printing plate to wash off the ink.

Still further, the present invention provides a printing press on which a printing plate is made ready for printing. The printing press comprises a plate cylinder having a curved surface for supporting a printing plate; an image forming unit for writing a non-image area by irradiating a portion of the surface of the printing plate with visible light so that a property of the photocatalyst at the irradiated portion converts form hydrophobic to make the irradiated portion serve as the non-image area; and a regenerating unit for deleting the image on the surface of the printing plate in accordance with a conversion of the property of the photocatalyst at the non-image area from hydrophilic to hydrophobic which conversion is caused by irradiating the surface of the printing plate with energy flux or by applying a mechanical stimulus to the surface of the printing plate. With this arrangement in the printing press on which a printing plate is made ready for printing, making a printing plate ready for printing and regenerating of a printing plate can be carried out, keeping the printing plate being mounted on the plate cylinder, so that it is possible to continue printing processes without interruption due to plate replacement.

The printing plate may be a separated form from a plate cylinder, around which the printing plate is wrapped, or the curved surface of the plate cylinder may function as a printing plate.

As a preferable feature, the printing press further comprises a plate cleaning unit for removing ink from the surface of the printing plate and an image area deleting unit for deleting an image area by irradiating the entire surface of the printing plate with activating light, i.e., light having a wavelength equal to or shorter than that of visible light. A satisfactory image area deleting unit irradiates the surface with weaker light than that from the image forming unit and is preferably an ultraviolet lamp irradiating weak ultraviolet light.

### BRIEF DESCRIPTION OF THE DRAWINGS

FIG. 1 is a sectional view showing the surface of a printing plate according to a first embodiment of the present invention and concurrently showing a coating layer thereof in a hydrophobic state;

FIG. 2 is a sectional view showing the surface of the printing plate according to the first embodiment of the present invention and concurrently showing a coating layer thereof in a hydrophilic state;

FIG. 3 is a schematic diagram illustrating procedural steps of making the printing plate of the first embodiment ready for printing and regenerating the printing plate;

FIG. 4 is a perspective view illustrating an example of an image (an image area) and a white background (a non-image area) formed on the printing plate;

FIG. 5 is a graph showing a change in contact angle (i.e., a hydrophobic/hydrophilic state) of the printing plate of the first embodiment according to time passage and steps performed; and

FIG. 6 is a diagram illustrating an example of a printing press on which the printing plate of the first embodiment is mounted.

### BEST MODE FOR CARRYING OUT THE INVENTION

An embodiment of the present invention will now be described with reference to the accompanying drawings.

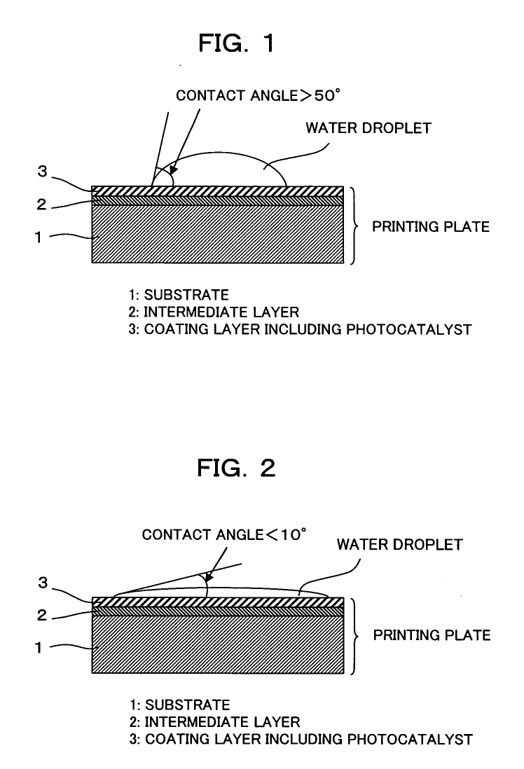

FIG. 1 is a sectional view showing the surface of a printing plate according to a first embodiment of the present invention. The printing plate basically includes a substrate 1, an intermediate layer 2, and a coating layer (a plate surface layer) 3. In this drawing, the substrate 1 is made of metal, such as aluminum or stainless steel, or a polymer film. However, the material of the substrate 1 of the present invention should by no means be limited to metal of aluminum or stainless steel, or a polymer film.

The intermediate layer 2 is formed on the surface of the substrate 1. The intermediate layer 2 is made, for example, of silica (SiO₂) or silicon compound such as a silicon resin or a silicon rubber. In particular, silicone alkyd, silicone urethane, silicone epoxy, silicone acryl, silicone polyester or the like is used as a silicone resin. The intermediate layer 2 is formed on the substrate 1 to ensure adhesion of the substrate 1 to a later-described coating layer 3 and to improve their firm adhesion. It is possible to ensure adequate adhesive strength between the substrate 1 and the coating layer 3 by interposing an intermediate layer 2 as required. If sufficient adhesive strength is available between substrate 1 and photosensitive layer 3, the intermediate layer 2 can be omitted. If the substrate 1 is made of a polymer film, the intermediate layer 2 may be formed in order to protect the substrate 1 as required. Additionally, if the later-described coating layer 3 is formed by heat treatment, the intermediate layer 2 is also effective for preventing impurities included in the substrate 1 from thermodiffusing and from thereby mixing into coating layer 3, so that a reduction in photocatalytic activity is avoided.

The coating layer 3 including a photocatalyst is formed on the intermediate layer 2 (or the substrate 1). The surface of the coating layer 3 comes to exhibit high hydrophilicity responsive to irradiation with activating light having energy higher than the band-gap energy of the photocatalyst. A photocatalyst originally does not show photocatalytic activity unless the photocatalyst is irradiated with light having energy higher than its band-gap energy; since a normal titanium oxide photocatalyst has band-gap energy as high as 3 eV, the photocatalyst is responsive only to ultraviolet light. However, the present invention utilizes, as a photocatalyst forming the coating layer 3, a photocatalyst having an energy level newly set in the band gap, which potocatalyst is thereby responsive also to light having a wavelength longer than that of ultraviolet light, so that visible light having a wavelength in the range between 400 nm through 600 nm can be used as the activating light as well as ultraviolet light.

Executing of a method already known produces a photocatalyst responsive even to visible light. For example, Japanese Patent Laid-Open (KOKAI) Publication No. 2001-207082 discloses a visible-light-responsive photocatalyst obtained by doping nitrogen atoms on the basis of a titanium oxide photocatalyst; Japanese Patent Laid-Open (KOKAI) Publication No. 2001-205104, a visible-light-responsive photocatalyst obtained by doping chromium and nitrogen atoms; and further Japanese Patent Laid-Open (KOKAI) Publication No. HEI 11-197512, a visible-light-responsive photocatalyst obtained by ion implantation using metal ions, such as chromium ions. A visible-light-responsive photocatalyst is produced by another disclosed method utilizing cryogenic plasma. A visible-light-responsive photocatalyst containing platinum is also disclosed. Fabrication of a printing plate according to the present invention can use a visible-light-responsive photocatalyst which has been produced in any of these known method.

In order to maintain the above hydrophilic property and to improve the strength of the coating layer 3 and the adhesion of the coating layer 3 to the substrate 1, the coating layer 3 including a visible-light-responsive photocatalyst may further include the following substance, such as a silica compound exemplified by silica, silica sol, organosilane, or a silicone resin, a metal oxide or a metal hydride including, for example, zirconium, aluminum, titanium, and/or a fluorocarbon resin.

The crystal structure of a base titanium dioxide photocatalyst is available in rutile, anatase and brucite. These structures are all usable in this embodiment, and they may be used in combination. Considering photocatalytic activity, the anatase structure is preferred because of the highest photocatalytic activity resulting from its crystal structure. As described below, a titanium oxide photocatalyst is preferably small in particle diameter in order to make photocatalytic activity high. Specifically, the particle diameter of a titanium dioxide photocatalyst is 0.1 μm or smaller, more preferably not greater than 0.05 μm. A preferable photocatalyst is a modified product based on a titanium oxide photocatalyst, but should by no means be limited to these examples.

The thickness of the coating layer 3 is preferably in the range of 0.005 to 1 μm because an unduly small thickness makes it difficult to fully utilize the above-described property while an excessively large thickness makes the coating layer 3 susceptible to cracks and causes a reduction in print durability. As this cracking is pronouncedly observed when the thickness exceeds 10 μm, it is necessary to consider this 10 μm as the upper limit even if one tries to enlarge this range of thickness. In practice, this thickness may preferably be set in the range of 0.03 to 0.5 μm or so.

The coating layer 3 is formed by a selected one of the sol coating processes, the organic titanate process, the sputtering process, the CVD method, the PVD method and other processes. If the sol coating process is adopted, for example, a sol coating formulation employed for use in the sol coating process may contain a solvent, a crosslinking agent, a surfactant and/or the like in addition to the titanium oxide photocatalyst and the above-described substances for improving the strength of the coating layer 3 and its adhesion to the substrate 1. The coating formulation may be either a room temperature drying type or a heat drying type, with the latter being more preferred because, in order to provide the resultant printing plate with improved print durability, it is advantageous to promote the strength of the coating layer 3 by heating. It is also possible to form the coating layer 3 of high strength, for example, by growing an amorphous titanium dioxide layer on a metal substrate by sputtering in a vacuum and then crystallizing the amorphous titanium dioxide by heat treatment or by another method.

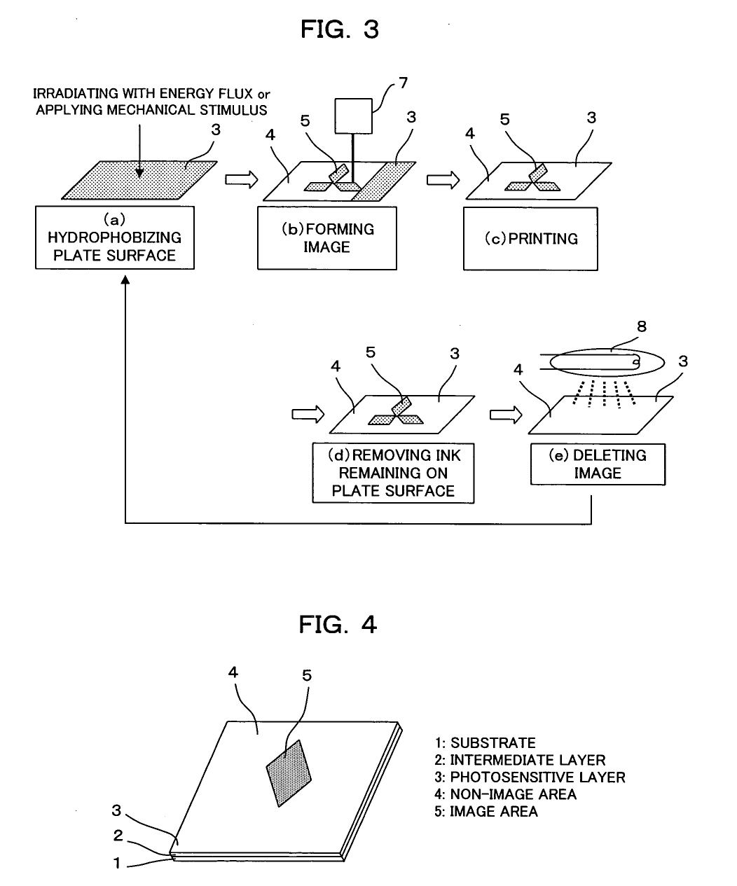

Hereinafter, the description will now be made in relation to a method for making the printing plate ready for printing and a method for regenerating the printing plate. FIG. 3 is a schematic diagram showing individual steps, in order of steps (a) to (e), from making a printing plate ready for printing to regenerating the printing plate. “Making the printing plate ready for printing” means writing of a hydrophilic non-image area by irradiating at least part of the surface of the printing plate, which has been hydrophobized, with activating light in accordance with digital data so that, together with one or more hydrophobic portions on the surface of the printing plate, which portions have not been irradiated with the activating light, a latent image including a hydrophobic image area and a hydrophilic non-image area is formed on the surface of the printing plate.

First of all, the surface of the coating layer 3 is irradiated with activating light so that the entire surface of the printing plate comes to a hydrophilic state in which a contact angle of water on the surface is 10° or smaller as shown in FIG. 2. Whereupon the entire surface of the coating layer 3 becomes hydrophilic and an image area formed on the printing plate is deleted. Although visible light can be used as the activating light to delete an image area, preferable activating light is weak ultraviolet light emitted from an ultraviolet irradiating lamp (a UV lamp) 8 as shown in FIG. 3 (e). Ultraviolet light is utilized because weak activating light is sufficient to delete an image area differently from forming an image and an ultraviolet irradiating lamp 8 is ordinary available on the market at a low cost.

Next, the entire surface of the printing plate is hydrophobized by irradiating the surface with energy flux of light, electricity or heat, or by applying a mechanical stimulus, such as friction, to the surface so that a property of the photocatalyst forming the coating layer 3 converts from hydrophilic to hydrophobic. A photocatalyst gradually converts in property from hydrophilic to hydrophobic when allowed to stand. It is known that such irradiation with energy flux or application of a mechanical stimulus such as friction enhances a conversion in the property of a photocatalyst from hydrophilic to hydrophobic. Step (a) represents a state in which the entire surface of the printing plate is hydrophobized. Here, the surface in a hydrophobic state has a contact angle of water thereon equal to larger than 50°, preferably equal to or larger than 80°, as shown in FIG. 1, which is in such a state that hydrophobic printing ink is held with ease but a fountain solution is hardly deposited. This state of the surface of the coating layer 3 is called “the initial state in making the printing plate ready for printing.” The “initial state in making the printing plate ready for printing” can be regarded as the start of an actual printing process. Specifically, the “initial state” means a state in which an arbitrary image, the digital data of which has been already prepared, is about to be formed onto the printing plate.

Subsequently, a non-image area 4 is written onto the surface of the coating layer 3 in a hydrophobic state to carry out an image forming step. Writing of a non-image area 4 is performed conforming to digital data of an image so as to coincide with the digital data. This non-image area 4 is in a hydrophilic state with a contact angle of water thereon equal to or smaller than 10°, in which the fountain solution is held with ease but the printing ink is hardly deposited as shown in FIG. 2.

For appearance of a hydrophilic non-image area 4 in line with image data, the activating light is irradiated a portion of the surface of the coating layer 3 and action of the photocatalyst hydrophilizes the irradiated portion of the surface of the coating layer 3. Since a portion that has not been irradiated with the activating light remains in a hydrophobic state, a latent image that is a combination of the hydrophobic image area 5 and the hydrophilic non-image area 4 is formed on the surface of the printing plate whereupon the printing plate is made ready for printing. In the illustrated example, a non-image area 4 is written with an imaging head 7 utilizing visible light exemplified violet leaser having a wavelength of 405 nm so that the non-image area 4 is formed on the hydrophobic surface of the coating layer 3 as shown in the step (b). This completes to form the image area 5 and the non-image area 4 on the coating layer and to make the printing plate ready for printing in which state that printing is ready to take place as shown in the step (c).

Here, visible light is used because of advantages of easy handling and compact size of the device. Alternatively, it is possible to use ultraviolet light, as the activating light, besides visible light. Any system utilizes light having a wavelength equal to or shorter than that of visible light, which system is exemplified by an imaging head equipped with a UV light source and a micro-mirror the product name of which is the UV-setter™ 710 manufactured by basysPrint GmbH (Germany), can be used as an imaging head for forming an image on the surface of the printing plate.

Upon completion of the above steps, a so-called emulsion ink of a mixture of a hydrophobic printing ink and the fountain solution is applied to the printing plate surface and thereby making a printing plate ready for printing as shown in FIG. 4 is completed. In FIG. 4, the hatching portion represents a state in which the hydrophobic ink is attached to the hydrophobic image area 5. The remaining white portion, i.e., the hydrophilic non-image area 4, represents a state in which the fountain solution preferentially adheres while the hydrophobic ink is repelled and be deposited. The emergence of an image allows the coating layer 3 to function as a printing plate ready for printing. After that, a normal printing process takes place and is accomplished.

Next, a method for regenerating the printing plate will now be described. “Regenerating of the printing plate” represents a conversion of a property of the photocatalyst from hydrophilic to hydrophobic to restore the printing plate to the initial state in making a printing plate by hydrophilizing the entire surface of the printing plate, at least part of which is exhibiting hydrophobic while the remaining part of which is exhibiting hydrophilic, and successively by irradiating the hydrophilic surface of the printing plate with energy flux of light, electricity, heat or the like independently or in any combination, or applying a mechanical stimulus such as friction to the surface of the printing plate.

At the beginning, ink, fountain solution, paper dust and the like remaining on the coating layer 3 after printing are removed at an ink removal step (step (d)). The ink removal is performed by one of moving ink to paper while a printing press is operating without supplying the printing plate with ink; wiping off ink with a reeled cleaning cloth tape; wiping off the ink with a roller around which cloth is wrapped; and by spraying a solvent having an effect on washing off ink onto the surface of the printing plate to washed off ink.

After that, as shown in step (e), the entire surface of the coating layer 3, at least part of which is exhibiting hydrophobic, is irradiated with the activating light so that the image area 5 is hydrophilized and the entire surface of the coating layer 3 becomes a hydrophilic surface, which has a contact angle with water thereon equal to or less than 10°, i.e., which is in a state shown in FIG. 2. Preferable activating light for hydrophilization is weak ultraviolet light emitted from a ultraviolet light (activating-light emitting lamp) 8, as the foregoing description.

Afterwards, the property of the photocatalyst is converted from hydrophilic to hydrophobic as shown at step (a) by irradiating the surface of the coating layer 3, which has been restored to hydrophilicity by irradiation with ultraviolet light, with energy flux of light, electricity, heat, or the like independently or in any combination, or by application a mechanical stimulus such as friction to the printing plate surface whereupon the coating layer 3 is restored to the initial state in making the printing plate. Meanwhile, the step (e) is performed in order to completely delete an image area formed on the printing plate. However, if the step (d) removes attached ink adequate enough not to affect on at least the next printing, the step (e) can be omitted and the step (d) is therefore followed immediately by the step (a).

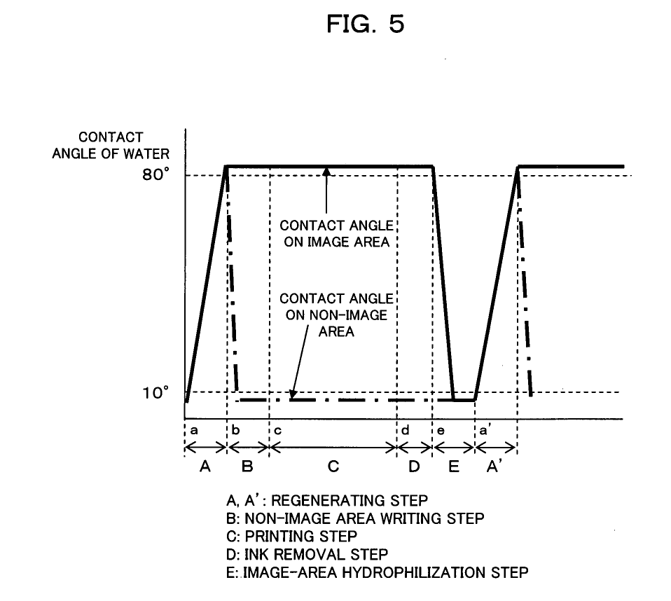

The above description is summarized in graph FIG. 5. Plots in abscissa represent time (or the procedural steps); and plots in ordinate represent the contact angle of water on the surface of printing plate. The graph indicates the change of the contact angle (i.e., a hydrophobic/hydrophilic state) of water on the surface of the coating layer 3 of this embodiment in accordance with the passage of time and performance of steps. The one-dotted line in the graph represents the contact angle of water on the non-image area 4 of coating layer 3; and the solid line, that on the image area 5.

First of all, the surface of the coating layer 3 is irradiated with the activating light (time point a) to become a high hydrophilic state in which the contact angle of water thereon is up to 10°.

In the first regenerating step (step A), the property of the photocatalyst is converted from hydrophilic to hydrophobic by irradiating the surface of the coating layer 3 with energy flux of light, electricity, heat, or the like independently or in any combination, or by applying a mechanical stimulus such as friction to the surface. The printing plate is in the initial state in making the printing plate when the regeneration by hydrophobization is completed and the surface of the coating layer 3 in this state has contact angle of water thereon equal to or larger than 50°, preferably down to 80°.

In succession, the activating light starts writing a non-image area 4 on a portion of the hydrophobic surface of the coating layer 3 (time point b) to perform a non-image area writing step (step B). As a consequence, the portion on the surface of the coating layer 3, which portion has been irradiated with the activating light, is converted from hydrophobic to hydrophilic by the action of the photocatalyst, that is, a contact angle of water on the irradiated portion becomes up to 10°. On the other hand, the remaining portion of the surface of the coating layer 3, which portion has not been irradiated with the activating light, remains hydrophobic so that the portion that is not irradiated with the activating light serves a hydrophobic image area 5 and the portion irradiated with the activating light serves a hydrophilic image area 4. Whereupon the surface of the coating layer 3 can function as a printing plate ready for printing. After completion of writing of the non-image area 4, printing process takes place (time point c) to perform the printing step (step C).

After completion of printing (time point d), ink, dust and the like are removed in ink removal step (step D). After the ink removal, irradiation of the surface of the coating layer 3 with the activating light is started (time point e) at the hydrophilization step (step E) for the image area 5. Thereby, the action of the photocatalyst converts the property of the hydrophobic image area 5 to that of the hydrophilic property whereupon the entire surface of the coating layer 3 becomes hydrophilic again (time point a′).

Then, the coating layer 3 is restored to the initial state in making the printing plate by irradiating the printing plate surface, with energy flux of light, electricity, heat, or the like independently or in any combination, or by applying a mechanical stimulus such as friction to the printing plate surface at the next regenerating step (step A′). The regenerated printing plate will be reused.

As mentioned above, the printing plate according to the first embodiment is advantageously reusable and additionally regeneratable in a short-term cycle. Since making a printing plate ready for printing and regenerating of the printing plate are performed simply by switching the property of the photocatalyst between hydrophilic and hydrophobic, processes for making ready for printing and regenerating do not require a long time. It is therefore possible to complete the entire printing process in an extreme short time.

Realization of regeneration and reuse of a printing plate can reduce the amount of printing plate waste discarded after printing. Since an image area 5 is not formed by hydrophobic material such as polymer, the washing solvent is not necessary to wash off the polymer for regeneration of the printing plate. The printing plate of the first embodiment is ecologically friendly, greatly reducing plate costs.

Since it is further possible to form an image onto the printing plate directly from digital data concerning the image, digitalization of a printing operation is realized, thereby greatly reducing corresponding time and costs.

The printing plate according to this embodiment utilizes a coating layer 3 including a photocatalyst responsive to visible light as well as ultraviolet light and a visible-light irradiator serves as an imaging head whereupon it is advantageously possible to make a printing plate ready for printing and regenerating the printing plate by an apparatus that is more tractable and smaller in size as compared with a system utilizing ultraviolet activating light.

Hereinafter is a description of an embodiment in relation to making and regenerating a printing plate with reference to the results of experiment and observation by the Inventors.

1. Preparation of Catalyst:

The Ammonia solution was added to a starting material of a titanium sulfate (a product of Wako Pure Chemical Industries, Ltd.) while stirring the mixture to obtain a titanium sulfate hydrolysate, which was filtered through a Buchner funnel. The residue titanium sulfate hydrolysate was washed with deionized water until electrical conductivity of the filtrate came to be 2 μS/cm or lower. After washing, the hydrolysate was dried at room temperature and then burned in the atmosphere for two hours at 400° C. The burned product was roughly milled with a mortar, and a powder-form photocatalyst was obtained.

2. Confirmation of Visible-Light Activity:

The above powder-form photocatalyst (0.2 g) was evenly spread over the bottom of a sealable cylindrical reaction container (500 ml) made of Pyrex® glass. The atmosphere in the reaction container was deaerated and substituted with highly-purified air. Acetone (500 ppm) was added into the reaction container and was absorbed into the photocatalyst in a dark place for 10 hours at 25° C. until the contents in the reaction container reached absorption equilibrium. After that, the contents were irradiated with light (having the major wavelength of 470 nm) emitted from blue LED (produced by Nichia Corporation). As a result of a follow-up measurement on amounts of acetone and carbon dioxide (CO₂) using a gas chromatograph manufactured by Shimazu Corporation, the Inventors confirmed that irradiation with light emitted from the blue LED for 25 hours decomposed all acetone in the reacting container and generated carbon dioxide CO₂ the amount of which corresponds to the stoichiometry proportion of the acetone. Namely, the Inventors have confirmed that the photocatalyst exhibited catalytic activity by light having a wavelength of 470 nm.

3. Making of Printing Plate:

The above powder-form photocatalyst was dispersed in deionized water to obtain slurry (solid content 20 wt %), which was milled in a wet mill (product name: dyno mill PILOT) and was used as a photocatalytic dispersed solution. Alkaline degreasing was performed on a stainless-steel (SUS301) substrate 1 the area of which was 280×204 mm and the thickness of which was 0.1 mm to prepare substrate for a printing plate.

Substrate 1 was dip-coated with the mixture of the photocatalytic dispersed solution and TKC-301, product of Tayca Corporation, at a weight ratio of 1:8, and was then heated at 350° C. to form the photocatalyst layer (coating layer) 3 on the surface of substrate 1, which was to serve as a printing plate. The coating layer 3 had a thickness of approximately 0.1 μm. As a result of measurement with contact angle meter, Model CA-W, manufactured by KYOWA INTERFACE SCIENCE CO., LTD., the surface of printing plate obtained a contact angle of 8° in relation to water thereon, which angle is enough to exhibit hydrophilicity.

4. Preparation of Printing:

The printing plate which exhibits hydrophilicity was soaked in Na₂SO₄ solution (concentration: 0.1M) and a lead was connected to the printing plate. The voltage +0.5 V is applied, for 5 minutes, to the printing plate being irradiated with ultraviolet light having an illuminance of 10 mW/cm². After that, the surface of the printing plate was air-dried and a contact angle of water thereon was immediately measured with the same contact angle meter and the result of the mesurement revealed that the contact angle was 75°, which would provide enough hydrophobicity, and that the printing plate was in the initial state in making the printing plate.

5. Image Forming:

Halftone dot images of halftone-dot-area percentages ranging from 10% to 100% at 10% intervals were formed on the surface of the printing plate by using an imaging unit that utilizes a semiconductor laser beam having a wavelength of 405 nm, an output of 5 mW/channel and a beam diameter of 15 μm. A contact angle of the surface of the printing plate after undergoing the image forming step and water thereon was measured using the above meter with the result that the contact angle of a portion was written with the semiconductor laser beam was 8° and that of a portion was not written was 75°, which angles are enough to be a hydrophilic non-image area 4 and a hydrophobic image area 5, respectively.

6. Printing:

The printing plate is mounted on the New Ace Pro desk-top offset printing press manufactured by ALPHA ENGINEERING INC., and the formed image was printed on sheets of ibest paper using an ink HYECOO-B Crimson MZ, product of Toyo Ink Mfg. Co., Ltd., and the fountain solution, a 1% solution of LITHOFELLOW, product of Mitsubishi Heavy Industries, Ltd., at a printing speed of 3,500 sheets/hour. The halftone dot images were successfully printed on the first paper sheet.

7. Regeneration:

An embodiment in relation to regeneration of a printing plate will now be described. After completion of printing, the entire surface of the printing plate, from which ink, fountain solution and paper dust remaining thereon is removed, was irradiated with ultraviolet light, having a wavelength of 254 nm and an illuminance of 10 mW/cm², emitted from a low-pressure Mercury lamp for 20 seconds. Immediately after that, the contact angle of water on a portion on which the halftone dot images were formed is measured with the same contact angle meter, and the measured contact angle was 8°, which is enough to exhibit hydrophilicity. The hydrophilized printing plate was soaked in Na₂SO₄ solution (concentration: 0.1M) and a lead was connected to the printing plate. The voltage +0.5 V is applied, for 5 minutes, to the printing plate being irradiated with ultraviolet light having an illuminance of 10 mW/cm². After that, the surface of the printing plate was air-dried and a contact angle of water thereon was immediately measured with the contact angle meter. The result of the mesurement reveled that the contact angle was 73°, which exhibited enough hydrophobicity, and that the printing plate was in the initial state in making the printing plate so that successful regeneration of the printing plate was confirmed.

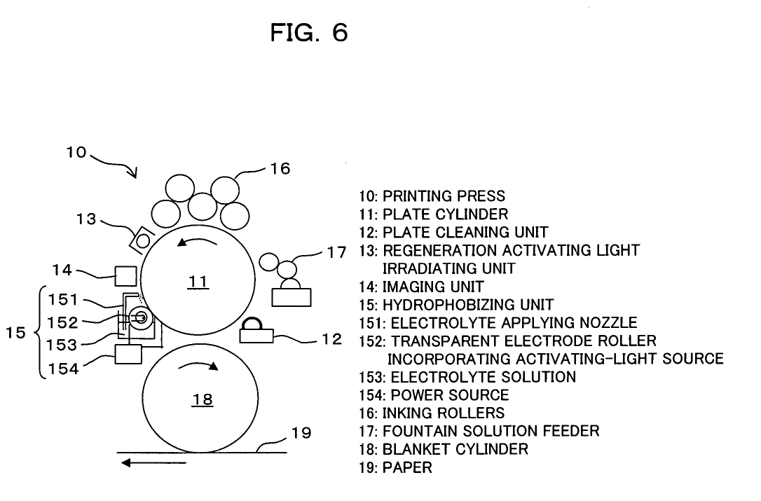

In order to perform printing and regenerating of a printing plate keeping mounted on a printing press, usage of the printing press 10 as shown in FIG. 6 is preferable. In the printing press 10, a plate cleaning unit 12, a regeneration activating light irradiating unit 13, an imaging unit 14, a hydrophobizing unit 15, inking rollers 16, a fountain solution feeder 17 and a blanket cylinder 18 are installed around the plate cylinder 11. The printing plate is wrapped around the curved surface of the plate cylinder 11.

In the printing press 10, the printing plate that has completed printing is regenerated by the following procedural steps. At the beginning, the plate cleaning unit 12 is come into contact with the plate cylinder 11 so that ink, fountain solution, paper dust and so forth remaining on the plate surface, i.e., the surface of the printing plate, are removed. The plate cleaning unit 12 appearing in FIG. 6 takes the form of a roller around which is cloth is wrapped to wipe off the ink on the plate surface, but can take an alternative form. After that, the plate cleaning unit 12 is disengaged from the plate cylinder 11 and the regeneration activating light irradiating unit 13 irradiates the entire surface of the printing plate with the activating light to hydrophilize the plate surface. The hydrophilization by the activating light can be performed if necessary in order to delete an image area, so should by no means be performed each time the printer is regenerated.

Then the hydrophobizing unit 15 evenly hydrophobizes the surface of the printing plate. The hydrophobizing unit 15 in the illustrated example is an apparatus that electrochemically hydrophobizes a print plate surface. Specifically, the hydrophobizing unit 15 includes a transparent electrode roller 152 incorporating an activating-light source, and moves the transparent electrode roller 152 incorporating an activating-light source closer to the surface of the printing plate mounted on the plate cylinder 11 until the space therebetween is narrowed to 100-200 μm. Thereby hydrophobization is performed on the printing plate as mentioned above and the printing plate is regenerated to the initial state in making the printing plate. At that time, electrolyte solution (Na₂So₄ solution used in the foregoing embodiment) 153 is applied, through an electrolyte applying nozzle 151, to the printing plate wrapped around the plate cylinder 11. A power source 154 is connected to the transparent electrode roller 152 incorporating an activating and the plate cylinder 11.

In succession, a non-image area is written into the printing plate with the imaging unit 14 based on digital image data previously prepared. A satisfactory light source of the imaging unit 14 emits the activating light and is preferably exemplified by a semiconductor laser emitting a beam having a wavelength of 400-500 nm, or a lamp emitting light in the range of visible to ultraviolet light. When the above step is completed, the inking rollers 16, the fountain solution feeder 17 and the blanket cylinder 18 come into contact with the plate cylinder 11. In this arrangement, paper 19 moves in the direction indicated by the arrow in FIG. 6, contacting with the blanket cylinder 18, so that fountain solution and ink is sequentially applied to the surface of the printing plate and printing is carried out.

It is possible for the printing press 10 to undergo the series of steps from regenerating of the printing plate to making the printing plate ready for printing—cleaning the printing plate after printing; deleting an image area by irradiation with the activating light; hydrophobizing the plate surface; and writing a non-image area—keeping the printing plate being mounted on the printing press 10. This enables the printing press 10 to perform continuous printing process without halting the operations and also without being interrupted by replacement of a printing plate.

As the structure of the printing press 10, the printing plate is wrapped around the plate cylinder 11, but the structure should by no means be limited to this. Alternatively, a photosensitive layer including a photocatalyst responsive to visible light as well as ultraviolet light may be formed directly on the plate cylinder 11, that is, the plate cylinder 11 and the printing plate is formed into one unit.

Further, the printing press 10 of the illustrated example does not include a dryer unit to dry the plate surface; alternatively, the printing press 10 may have an independent device serving as a dryer unit. A dryer unit may be in the form of a unit for drying the plate surface by, for example, hot or cold air, or a unit for heat-drying the plate surface by radiant heat.

What is claimed is:

1. A reusable printing plate on which an image is formed by irradiating a surface of the printing plate with light and which is regenerated by deleting the formed image, wherein a layer (3) serving as the surface of said printing plate includes a photocatalyst that responds to visible light as well as ultraviolet light because of setting a new level in a band gap of a titanium oxide photocatalyst.

2. A printing plate according to claim 1, wherein the photocatalyst responds to light having a wavelength equal to or shorter than 600 nm.

3. A printing plate according to claims 1 or 2, wherein a conversion in a property of the photocatalyst causes formation of the image on the surface of said printing plate and regeneration of said printing plate.

4. A printing plate according to claim 3, wherein the property of the photocatalyst converts from hydrophilic to hydrophobic and converts from hydrophobic to hydrophilic.

5. A printing plate according to claim 4, wherein the property of the photocatalyst is converted from hydrophobic to hydrophilic by irradiating the surface of said printing plate with visible light.

6. A printing plate according to claim 5, wherein the property of the photocatalyst is converted from hydrophilic to hydrophobic by irradiating the surface of said printing plate with energy flux or by applying a mechanical stimulus to the surface of said printing plate.

7. A printing plate according to one of claims 1-6, wherein the photocatalyst is a modified titanium oxide photocatalyst.

8. A method for regenerating and reusing a printing plate defined in claim 6, comprising the steps of:
upon completion of printing,
removing ink from the surface of the printing plate;
regenerating the printing plate by deleting the image formed on the surface of the printing plate in accordance with a conversion of a property of the photocatalyst at a non-image area from hydrophilic to hydrophobic which conversion is caused by irradiating the surface of the printing plate with energy flux or by applying a mechanical stimulus to the surface of the printing plate; and
forming an image on the surface of the printing plate by irradiating a portion of the surface with visible light so that a property of the photocatalyst at the irradiated portion converts from hydrophobic to hydrophilic to make the irradiated portion serve as a non-image area.

9. A method for regenerating and reusing a printing plate according to claim 8, further comprising the steps of:
before the conversion of the property of the photocatalyst to hydrophobic to hydrophilic in said step of regenerating,
irradiating the entire surface of the printing plate with light having a wavelength equal to or shorter than that of visible light.

10. A method for regenerating and reusing a printing plate according to claims 8 or 9, wherein said step of ink removing is performed by moving the ink to paper while a printing press is operating without supplying the printing plate with ink.

11. A method for regenerating and reusing a printing plate according to claims 8 or 9, wherein said step of ink removing is performed by wiping off the ink with a reeled cleaning cloth tape.

12. A method for regenerating and reusing a printing plate according to claims 8 or 9, wherein said step of ink removing is performed by wiping off the ink with a roller around which cloth is wrapped.

13. A method for regenerating and reusing a printing plate according to claims 8 or 9, wherein said step of ink removing is performed by spraying a solvent having an effect on washing off ink onto the surface of the printing plate to wash off the ink.

14. A printing press comprising:
a plate cylinder (11) having a curved surface for supporting a printing plate defined in claim 6;
an image forming unit (14) for writing a non-image area by irradiating a portion of the surface of the printing plate with visible light so that a property of the photocatalyst at the irradiated portion converts from hydrophobic to make the irradiated portion serve as the non-image area; and
a regenerating unit (15) for deleting the image on the surface of the printing plate in accordance with a conversion of the property of the photocatalyst at the non-image area from hydrophilic to hydrophobic which conversion is caused by irradiating the surface of the printing plate with energy flux or by applying a mechanical stimulus to the surface of the printing plate.

15. A printing press according to claim 14, further comprising a plate cleaning unit (12) for removing ink from the surface of the printing plate.

16. A printing press according to claim 14 or 15, further comprising an image area deleting unit (13) for deleting an image area by irradiating the entire surface of the printing plate with light having a wavelength equal to or shorter than that of visible light.
